(19) United States
(12) Patent Application Publication
(10) Pub. No.: US 2004/0052924 A1
(43) Pub. Date: Mar. 18, 2004

(54) Functional cereals

(75) Inventor: Sachiko Kimura, Kanagawa (JP)

Correspondence Address: Dowell & Dowell, P.C., Suite 309, 1215 Jefferson Davis Highway, Arlington, VA, 22202, US

(73) Assignee: SOUSHIN CORPORATION.

(21) Appl. No.: 10/660,589

(22) Filed: Sep. 12, 2003

Related U.S. Application Data
(63) Continuation of application No. PCT/JP02/02287, filed on Mar. 12, 2002.

(30) Foreign Application Priority Data
Mar. 14, 2001 (JP) 2001-071958

(51) Int. Cl. A23L 1/20

(52) U.S. Cl. 426/626

(57) ABSTRACT

Functional cereals are provided in which the melatonin content of the cereals is increased by germinating the cereals under fixed conditions and a physiological activity and a function of reducing the odor of stool are added by the physiologically active substance melatonin and/or dietary fibers as active ingredients. Further, it has been found that high-quality and uniform germinated cereals are produced by germination using melatonin as an index.

### CROSS-REFERENCE TO RELATED APPLICATIONS

This is a continuation of Application PCT/JPO2/02287, filed Mar. 12, 2002, now abandoned.

### BACKGROUND OF THE INVENTION

1. Field of the Invention

The present invention relates to functional cereals in which the melatonin content and/or the dietary fiber content is increased by germination, a process for producing the same, and a processed food obtained by processing the same.

2. Description of the Related Art

In recent years, as the intake of light processed foods has increased, unbalanced nutrition has resulted, and a relation between many diseases such as life-style related diseases and foods has come to attract much interest. Moreover, since abundant foodstuffs are available, an important role of foods is now to satisfy specific health interests. For this reason, studies on nutrient supplements and functional foods for improving or supplementing inadequate eating habits have been actively conducted.

Melatonin (chemical name: N-acetyl-5-methoxytriptamine) is a hormone formed from tryptophan via serotonin in the pineal body of animals. It is related with senescence, and has an important significance as a hormone whose secretion is suppressed with aging.

With respect to melatonin, various physiological activities such as an immunopotentiation activity (J. Pineal Res. vol. 4, 1-10, 1993), an antiviral activity, an antitumor activity (CRC Critical Rev. Clin. Lab. Sci. vol. 25, 231-253, 1987, New. Eng. J. Med. vol. 336, 186-195, 1997) and a sleep-inducing activity (Sleep, vol. 70, 65-71, 1993, Biol. Psychiatry, vol. 33, 526-530, 1993) have been reported. It is known that the melatonin level in the blood of humans gradually decreases with aging, and this phenomenon of decreasing amounts of melatonin is said to be a serious sign of aging. Accordingly, the intake of melatonin with aging has been increasingly studied.

Melatonin is present in natural foodstuffs in a very small amount (Biochem. & Molecular Biology international, vol. 35(3), 627-634 (1995)), and it is difficult to obtain substantial amounts from natural substances. Accordingly, chemically synthesized melatonin has been made available commercially. Generally, chemically synthetic products are the subject of concern due to safety and quality issues, in view of potential problems with impurities such as chemical agents used during synthesis. Therefore, natural substances Therefore, natural substances are considered preferable and the demand has accordingly increased.

With respect to dietary fibers, there are many reports on studies of the positive influence and usefulness for prevention of obesity, prevention and improvement of constipation, excretion of harmful substances, control of cholesterol in blood, blood sugar level and endobacteria. The criterion for the necessary amount of dietary fiber for one adult person is deemed to be approximately 20 g. Especially as processed foods are increasingly consumed, the intake of dietary fibers is needed.

Generally, cereals have been long used and produced as important food resources for humans. Cereals containing dietary fibers in large quantities are said to be excellent foodstuffs with well-balanced nutrition. Cereals contain ingredients which are hardly used in a raw state or have properties which are not exhibited in the raw state. However, since cereals become foodstuffs appropriate for human intake by processing such as removal of hulls without loss of nutritional value, they are used as the principal food for humans. If new functionality can be added to cereals, great advantages can be expected.

Studies on processing have long been directed to bean sprouts obtained by germinating beans, and a method for producing the same have been reported(JP-A-10-117511, JP-A-5-76245 and JP-A-9-248065). Various studies have been conducted to provide new foodstuffs by activating enzymes inherent in cereals through germination. With respect to beans, barley and wheat, studies have been conducted on the use of extracts obtained by germination (JP-A-60-221067) and on a method for producing germinated brown rice in which germination secures nutrients of brown rice and also makes brown rice easier to eat (JP-A-2000-2117520 and JP-A-9-163941).

However, these studies are directed to foods in which cereals are processed by making use of nutrients inherent in cereals, not to the addition of a specific function.

Further, since nutrients inherent in cereals are essential elements required for cereals to germinate and grow, they are reduced by excessive processing. Accordingly, in order to use cereals as foodstuffs while retaining the nutrients inherent therein, appropriate processing is needed. To this end, an absolute index on the processing is required. Since germination is the only index in these studies, it is difficult to make and provide high-quality and uniform cereals.

### SUMMARY OF THE INVENTION

This invention aims to provide, by germination, new functional cereals in which the content of melatonin as a physiologically active ingredient and/or the content of dietary fibers is increased by inducing nutrients or functional ingredients inherent in cereals to the maximum extent and functional cereals having a function of reducing the odor of stool. Further, the invention aims to provide a process for producing functional cereals, and a process for producing high-quality germinated cereals by using melatonin as an index. Further, the invention aims to provide a processed food by processing the functional cereals.

The present inventors have assiduously conducted investigations to solve the foregoing problems. Consequently, during studies on germination of cereals, we have found that cereals, when germinated under fixed conditions, exhibit a function of increasing the melatonin content and that a physiological activity of melatonin and/or a physiological activity of dietary fibers as an active ingredient can newly be added to cereals by this germination. Moreover, it has been found that cereals have a function of reducing the odor of stool of humans. In addition, it has been found that high-quality and uniform germinated cereals are produced by germination using melatonin as an index.

This summary of the invention does not necessarily describe all necessary features so that the invention may also be sub-combination of these described features.

### BRIEF DESCRIPTION OF THE DRAWINGS

FIG. 1 is a graph showing a germination rate in brown rice when using a germination solution and the process of the invention.

FIG. 2. is a graph showing results of measuring melatonin content with time following germination of brown rice using a germination solution, i.e. a lactate buffer solution of the invention.

FIG. 3 is a graph showing results of measuring melatonin content with time during germination of rye using a germination solution, i.e. a lactate buffer solution of the invention.

FIG. 4 is a graph showing results of measuring melatonin content with time during germination of green soybeans using a germination solution, i.e. a lactate buffer solution of the invention.

### DETAILED DESCRIPTION OF THE INVENTION

The invention will now be described based on embodiments which do not intend to limit the scope of the present invention but exemplify the invention. All of the features and the combinations thereof described in the embodiments are not necessarily essential to the invention.

The germination referred to in the present application means that cereals are processed under fixed conditions to activate the resting state of seeds, induce nutrients inherent in cereals and newly induce functional ingredients.

Regarding the cereals as raw materials in the invention, any types of cereals, namely, rice with hulls, barley or wheat with hulls, dehulled rice (so-called brown rice), dehulled barley or wheat, bean seeds or corn seeds can be used because inherent functions of cereals are induced by germination. Cereals of the types which are generally used for daily food are preferable. Rice may be rice with hulls or brown rice, and all varieties of rice can be used. Barley and wheat may be barley, wheat, rye and the like which are dehulled can be used. Any type of been seeds, for example, soybeans, adzuki beans, peanuts and peas, can be used.

The germination of the invention is not ordinary germination. The characteristic feature is that the germination is conducted using an aqueous solution with an acidic buffer. The acidity is preferably pH of 6 or lower. The pH is more preferably between 2.5 and 6. For the adjustment of pH, an edible acid can be used. Examples thereof include organic acids such as citric acid, malic acid, lactic acid and acetic acid, and inorganic acids such as phosphoric acid. of these, lactic acid is preferable. A buffer solution is prepared using these acids, and can be used as an aqueous solution. The concentration of the buffer solution is 500 mM or less, preferably from 10 mM to 500 mM, most preferably from 30 mM to 100 mM.

The germination is conducted using the foregoing aqueous solution, whereby melatonin as an index is induced to a maximum extent and the growth of microorganisms adhering to the raw materials can be inhibited as shown in Tables 1, 2 and 3.

TABLE 1

| | Germination rate | Bacterial count |
|---|---|---|
| Germination solution | 69.9% | General bacteria are |
| (Example 1) is used. | | not detected. |
| | | E. coli is not |
| | | detected. |
| Ultraviolet | 71.3% | General bacteria 1.0 |
| sterilized water | | to 8.0 × 10⁷ CFU/g |
| | | E. coli 1.5 to 5.0 × |
| | | 10⁷ CFU/g |

TABLE 2
Unit: Bacterial count/ml

| | Brown rice | | | Wheat | |
|---|---|---|---|---|---|
| Germina- | | Germina- | Germina- | | Germina- |
| tion time | Tap water | tion | tion | Tap water | tion |
| (h) | (control) | solution 1 | solution 2 | (control) | solution 1 |
| 0 | 0 | 0 | 0 | 0 | 0 |
| 0.5 | 0 | 0 | 0 | 0 | 0 |
| 2 | 0 | 0 | 0 | 0 | 0 |
| 4 | 0 | 0 | 0 | 0 | 0 |
| 6 | 0 | 0 | 0 | 0 | 0 |
| 8 | 0 | 0 | 0 | 0 | 0 |
| 9 | — | 0 | 0 | 3 | 0 |
| 10 | — | 0 | 0 | 10³ | 0 |
| 17 | 9.1 × 10⁵ | 0 | 0 | — | 0 |
| 20 | 4.1 × 10⁸ | 0 | 0 | 10⁵ | 0 |
| 24 | 8.3 × 10⁷ | 0 | 0 | 10⁵ | 0 |
| 30 | — | 0 | 0 | — | 0 |

TABLE 3
Unit: Bacterial count/ml

| | Rye | | Barley | | Oat | |
|---|---|---|---|---|---|---|
| Germination | Tap water | Germination | Tap water | Germination | Tap water | Germination |
| time (h) | (control) | solution 1 | (control) | solution 1 | (control) | solution 1 |
| 0.5 | — | — | 10⁵ | — | 10⁴ | — |
| 2 | 2 | 0 | 10⁵ | — | 10³ | — |
| 4 | 10 | 0 | 10⁵ | — | 10⁴ | — |
| 6 | — | — | 5 × 10⁵ | — | 10⁵ | — |
| 9 | 10⁴ | 0 | 10⁶ | — | 10⁶ | — |
| 17 | 5 × 10⁴ | 0 | 5 × 10⁵ | 0 | 5 × 10⁶ | 0 |
| 24 | 5 × 10⁴ | 0 | 10⁷ | 0 | 5 × 10⁴ | 0 |
| 30 | 5 × 10⁵ | 0 | 10⁷ | 0 | 10⁵ | 0 |

The other important germination conditions are temperature and oxygen content. It is important to supply a sufficient amount of oxygen to cereals. When germination is conducted by dipping, oxygen fed to cereals is defined by the amount of dissolved oxygen of the aqueous solution used for dipping. It is advisable to secure an amount of oxygen sufficient for germination. Specific examples thereof include a method in which an acid aqueous solution is aerated with air or oxygen and germination is conducted while feeding oxygen to the aqueous solution and a method in which cereals are showered with an acid aqueous solution and contacted with oxygen to satisfy a germination atmosphere.

The germination temperature is preferably in the range from 0° C. to 35° C. The germination time can be defined by using the melatonin content as an index. For example, when brown rice is used as a raw material, the germination is stopped when the melatonin content reaches equilibrium (approximately 40 mg/100 g). Generally, the germination time is prolonged at low temperatures. As a standard, the germination is conducted at 0° C. for 24 hours or less, and from 30° C. to 35° C. for 12 hours or less. For example, to control the growth of adhered bacteria, cereals are showered with an aqueous solution with an acidic buffer at a low temperature and germinated for 24 hours or less, whereby melatonin formation can be induced to a maximum extent.

The thus-germinated cereals can be rendered in a state capable of withstanding storage by heat-treatment, drying with hot air, freeze-drying, and refrigeration or freezing in a usual manner.

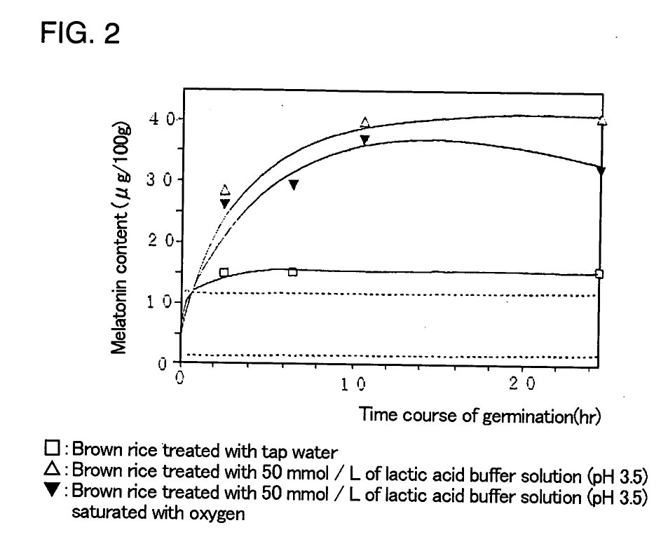

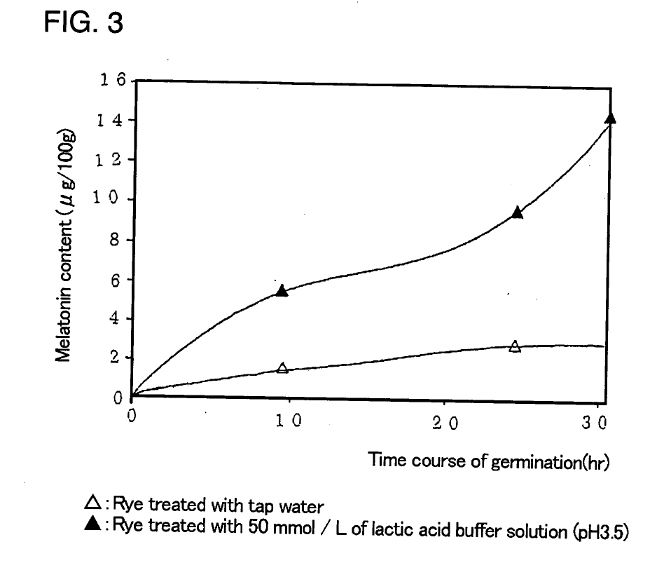

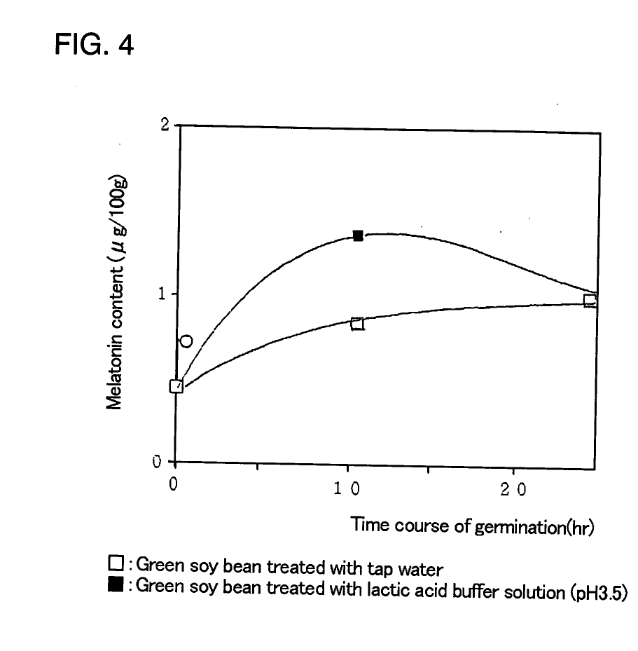

The melatonin content and the dietary fiber content of the germinated cereals are shown in Table 4 and FIGS. 2, 3 and 4. In the cereals prepared according to the invention, the melatonin content and/or the dietary fiber content can be induced to a significantly high extent in comparison to the content(s) inherent in cereals.

TABLE 4

| | | | after 24 |
|---|---|---|---|
| | 0 hour | 6 hours | hours |
| Ungerminated brown rice | | | |
| free GABA (mg/100 g) | 15.2 | | |
| dietary fibers (g/100 g) | 3.2 | | |
| Lactate buffer solution | | | |
| free BAGA (mg/100 g) | 15.2 | 22.7 | 20.2 |
| dietary fibers (g/100 g) | 3.2 | 3.8 | 3.7 |
| Saturated lactate buffer solution | | | |
| free GABA (mg/100 g) | 15.2 | 22.7 | 20.2 |
| dietary fibers (g/100 g) | 3.2 | 3.9 | 3.6 |

The cereals with the melatonin content increased by the germination have a physiological activity of melatonin. It is well known that melatonin in human bodies exhibits important physiological activities such as preventing effects of aging , preventing age-related diseases, and the like (Bioassays, vol. 14, 169-172, 1992, Aging, vol. 3, 103-106, 1991). A physiological concentration of melatonin in blood is higher at night than during the day, and decreases with aging. The value is approximately 80 pg/ml (in night) in younger people, and 10 pg/ml (in night time) in the elderly (J. Clin. Endocrin. & Met., vol. 55, 27-29, 1982). Supplementation decreased melatonin through daily meals is quite effective for prevention of aging. However, the melatonin content is inherently extremely low in cereals, and ordinary foodstuffs including cereals cannot be expected to be sources of melatonin.

The germinated cereals of the invention have a satisfactory melatonin content in amounts in which cereals are usually eaten. For example, when germinated brown rice is eaten in an amount of 100 to 300 g/meal for three meals (morning, noon and evening) in one day, a known physiologically active amount of melatonin (Proc. Natl. Acad. Sci. U.S.A., vol. 91, 1824-1828, 1994) can be taken in. Further, the dietary fiber content is also significantly increased, and the content by which the physiological activity is satisfactorily exhibited is provided in amounts in which cereals are usually eaten.

When the germinated cereals are eaten by humans, a function of reducing the odor of stool is provided in amounts of cereals which are usually eaten as shown in table 5. It is uncertain to what ingredient the function of reducing the odor of stool is attributed. Presumably, the germinated cereals influence intestinal flora of humans to act on reduction in the odor of stool.

TABLE 5
Effect for reducing the odor of stool

| Subject No. | At the outset | Week 2 | Week 4 |
|---|---|---|---|
| 1 | + | ± | − |
| 2 | + | − | − |
| 3 | + | − | − |
| 4 | + | ± | − |
| 5 | + | − | − |
| 6 | + | − | − |
| 7 | + | ± | − |
| 8 | + | − | − |
| 9 | + | − | − |
| 10 | + | − | − |
| 11 | + | ± | − |
| 12 | + | ± | − |
| 13 | + | − | − |
| 14 | + | − | − |
| 15 | + | − | − |
| 16 | + | − | − |
| 17 | + | − | − |
| 18 | + | − | − |
| 19 | + | ± | − |

−: Clear reduction was observed.
±: Unchanged
+: Very bad

The germinated cereals of the invention are foodstuffs which can be used as daily food having a new functionality.

The functional cereals of the invention are available as processed foods, foods for specified healthy uses, healthy drinks, nutrient supplements, various types of other foods and drinks or additives thereto for maintaining and promoting health.

Moreover, the processed products thereof can also be used by being molded into drugs, namely, by adding appropriate excipients (lactose, cornstarch, crystalline cellulose and the like) to the cereals and shaping the mixture into various dosage forms (tables, capsules, powders, fine granules, granules and the like).

In addition, when producing processed foods, nutrient supplements, other foods and drinks using the functional cereals of the invention, the purpose can be attained by employing general processed food techniques known to those skilled in the art.

The functional cereals with the melatonin content and/or the dietary fiber content increased by the germination according to the invention are new foodstuffs having the effective contents of melatonin and dietary fibers of which the physiological activity has been already known in an ordinary amount per meal from 100 to 300 g. Accordingly, the functional cereals with the melatonin content and/or the dietary fiber content increased by the germination and the functional cereals having the function of reducing the odor of stool by the germination are eaten as part of daily meals, whereby the physiological activity of melatonin and/or dietary fibers and the function of reducing the odor of stool are expected, and these cereals are effective as foodstuffs for health promotion and as foodstuffs for the aged. Moreover, the high-quality functional cereals can be produced by using melatonin as an index.

### EXAMPLES

The invention is specifically illustrated below by referring to Test Examples. However, the invention is not limited to these specific Examples.

### Example 1

Method for Germination Using a Lactate Buffer Solution

Rice (Kinuhikari, brown rice), barley and wheat (wheat, barley, rye and oat) and soybeans (yellow soybeans and green soybeans) were used in the germination.

Lactic acid (4.5g) (DL lactic acid: Wako Pure Chemical) was dissolved in approximately 900 ml of tap water, and the solution was controlled to pH of 3.5 with 2N sodium hydroxide (Wako Pure Chemical). The resulting solution was then adjusted to a 0.05 mol/L lactate buffer solution (pH 3.5) which was designated germination solution 1. Subsequently, oxygen was fully blown therein to give a 0.05 mol/L lactate buffer solution (pH 3.5) saturated with dissolved oxygen which solution was designated germination solution 2. The germination solution was used in an amount of approximately 500 ml per 50 g of seeds.

Fifty grams of the respective seeds used in the germination was measured, washed with tap water, then dipped again in tap water, and allowed to stand at room temperature for 30 minutes.

After dipping and allowing to stand, tap water was discarded, 500 ml of germination solution 1 or 2 was immediately added, and the resulting seeds in the germination solution were warmed in a water bath of 30° C. A comparative examination was performed by using tap water as a control instead of the germination solution.

The samples were withdrawn at 30 minutes, and 1, 2, 3, 4, 5, 6, 8, 10, 20 and 24 hours in the case of brown rice, at 2, 4, 6, 9, 17, 24 and 30 hours in the case of barley and wheat, and at 10, 24 and 30 hours in the case of soybeans. Necessary amounts thereof for respective analysis were drained well, and then pulverized and frozen.

### Example 2

Method for Germination in which Showering is Performed Using a Lactate Buffer Solution

Brown rice “Akita Komachi” was used as seeds for germination. In a water circulation method, germination solution 1 as a lactate buffer solution shown in Example 1 was circulated using a circulation pump. The circulated lactate buffer solution was sprayed on 100 g of brown rice “Akita Komachi” put in a net basket. For satisfying the same requirements as in germination solution 2 saturated with dissolved oxygen, water and oxygen were fed to brown rice. As a control, brown rice sprayed and circulated with only water subjected to treatment with an ultraviolet lamp (dose of ultraviolet rays 6,500 mW/cm2) was also examined. The circulation water was maintained at 32° C. After 24 hours, tests were performed for germination rate, general bacteria and Escherichia coli. The results are shown in Table 1. The germination rates were the same for the germination solutions and the control solutions. In addition, the use of the germination solution of the invention completely controlled the growth of bacteria.

### Example 3

Analysis of Ingredients after Germination Using a Lactate Buffer Solution

Regarding the respective seeds germinated in Example 1, the germination condition, the pH, the change in weight by germination, the free melatonin content, the dietary fiber content, the bacterial counts, the Escherichia coli count and the water content were measured at the respective collection times.

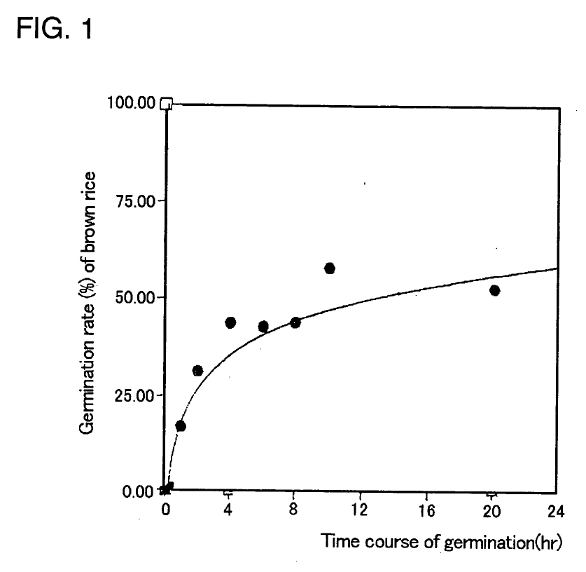

The germination condition was observed through a stereoscopic microscope by thawing, just before the observation, the seeds collected with time and frozen. The results of the visually observed germination condition of brown rice as a typical example are shown in FIG. 1. Bacteria were counted by using a measurement kit “bacterial count measurement easy medium “Easy Cult” (Orion Diagnostics). The results are shown in Tables 2 and 3. It was found that the use of the germination solution of the invention could completely control the growth of bacteria. Meanwhile, the use of tap water could not control the growth of bacteria.

In the Tables, germination solution 1 indicates the lactate buffer solution shown in Example 1, and germination solution 2 indicates the lactate buffer solution saturated with dissolved oxygen as shown in Example 1.

### Example 4

Analysis of Ingredients, Namely, Dietary Fibers and the like after Germination Using a Lactate Buffer Solution

The dietary fiber content (Southgate method), the water content and the GABA content were measured using the respective seed samples used in Examples 1 and 2. Since all of the samples contained water, the comparison was made such that the water content of each sample was measured and calculated in terms of the content of a dry sample (water content 0%) obtained by subtracting the water content of each sample from the measured value of the ingredient.

The results of brown rice in Example 1 as a typical example are shown in Table 4.

These results revealed that the dietary fibers were increased by the germination of the invention in comparison to non-germinated brown rice.

### Example 5

Measurement of a Melatonin Content after Germination Using a Lactate Buffer Solution

Two grams of the sample was measured, and 20 ml of dichloromethane was accurately added thereto. After sonication for 1 minute, the dichloromethane suspension was shaken for 30 minutes and followed by centrifugation, and 10 ml of a dichloromethane layer was accurately taken and evaporated to dryness under nitrogen stream. Accurately, 1 ml of a mobile phase was added thereto, and the mixture was sonicated for 1 minute, and then filtered with shaking. The filtrate was designated a sample solution.

Separately, melatonin mobile phase solution in an amount of 10 to 320 ng/ml was prepared, and used as a standard solution for a calibration curve. For 20 ml of the sample solution or the standard solution for a calibration curve, a melatonin peak area was measured by HPLC under the following conditions, and the melatonin content in the sample was obtained from a calibration curve.

HPLC conditions

| | |
|---|---|
| Detector: | fluorescent detector |
| | (ex. 283 nm, em. 333 nm) |
| Column: | STR ODS II (250 nm × 4.6 nm I.D.) |
| Column temperature: | 50° C. |
| Sample storage temperature: | 5° C. |
| Mobile phase: | 0.05 nmol/L ammonium phosphate buffer |
| | (pH 3.5)/methanol mixed solution(70:30) |
| Flow rate: | 1 ml/min |

The changes with time of the melatonin content in Example 1 using brown rice, rye and green soybeans as typical examples are shown in FIGS. 2, 3 and 4.

It was identified that all the seeds were outstandingly increased in melatonin content as compared to those treated with tap water. Consequently, it was judged that the delicate movement within the seeds could be monitored by using the melatonin content as an index in the germination. Especially in the brown rice and rye, it was determined that melatonin content was approximately 10 times higher than before germination. Also in green soybeans, the melatonin content was approximately 3 times higher than before germination.

### Example 6

Examination on a Function of Reducing the Odor of Stool

Nineteen bedridden elderly patients from 70 to 92 years old and requiring nursing-care (habitual constipation) were fed rice gruel cooked using 200 g of germinated brown rice three times a day for 4 weeks. The effect against the odor of stool was observed to examine the influence on intestinal flora. The results are shown in Table 5.

The effect against the odor of stool was observed every two weeks. Consequently, on week 2 after starting to eat the rice gruel, a clear effect for reducing the odor of stool was observed in 13 cases. On week 4, the reduction in the odor of stool was observed in all cases. This displayed that the germinated brown rice had the function of normalizing the intestinal flora.

### Example 7

Preparation of Rice Gruel

Brown rice “Kinuhikari” germinated for 12 hours using germination solution 2 shown in Example 1 was thoroughly drained. Rice gruel was prepared with this germinated brown rice. The thus-obtained rice gruel was packed in a commercial retorting pack or a tin, sealed, and retorted at 120° C. for 20 minutes to give the product.

Example 8

Preparation of a Healthy Drink

Brown rice “Kinuhikari” germinated for 12 hours using germination solution 2 shown in Example 1 was thoroughly drained, and then dried in an atmosphere between 40° C. and 80° C. for 4to 5 hours. The resulting dried rice was pulverized with a grinder, and a part of the powder was used as starting material for capsules and tablets. From 70 to 75% by weight, based on the total amount, of the remaining germinated brown rice, from 20 to 25% by weight of water and from 1 to 5% of malt were taken, fully mixed, and dissolved by being heated at 120° C. to form a solution. After the solution was filtered through a filter cloth, the filtrate was heated between 60 and 70° C. for 5 hours to provide a saccharified product. This saccharified product was diluted with water at a product:water ratio of 1:9. Sweeteners such as honey and sugar were added thereto to form a drink raw material. Half of the drink raw material was added to a tin container, and the container was sealed by seaming. Subsequently, retorting was conducted at 120° C. for 20 minutes to give a germinated brown rice drink product.

A commercial chlorella extract CGF was added to the total amount of the remaining germinated brown rice powder at a ratio of 200g of brown rice powder to 200ml of chlorella extract, and the mixture was likewise packed in a tin, and sealed by seaming. Subsequently, retorting was conducted at 120° C. for 20 minutes to give a chlorella-containing brown rice drink product.

### Example 9

Preparation of Cakes

Margarine and sugar were whipped at a ratio of 4:3 to reduce the specific gravity of a raw material. A whole egg was added to this raw material at a raw material to whole egg ratio of 1:3 to form cream. To this was added the germinated brown rice powder shown in Example 8, and they were gently mixed to prepare dough. The content of the germinated brown rice was approximately 52% by weight in terms of a dry solid.

The dough was immediately shaped into pieces each having a thickness of 1 cm, a width of 2 cm and a length of 8 cm, and baked in an oven at 150° C. for 25 minutes to provide germinated brown rice cakes.

Although the present invention has been described by way of exemplary embodiments, it should be understood that many changes and substitutions may further be made by those skilled in the art without departing from the scope of the present invention which is defined by the appended claims.

What is claimed is:

1. A functional cereal, wherein a melatonin content and/or a dietary fiber content is increased by germination in the pH range between 2 and 6.

2. The functional cereal of claim 1, wherein the melatonin content is increased by germinating any of seeds of brown rice, barley, wheat, beans or corn in pH range between 2 and 6.

3. The functional cereal of claim 1, which has physiological activity with melatonin and/or dietary fibers as active ingredient.

4. The functional cereal of claim 2, which has physiological activity with melatonin and/or dietary fibers as active ingredient.

5. The functional cereal of claim 1, wherein the melatonin content is 25 mg/100 g or more.

6. The functional cereal of claim 2, wherein the melatonin content is 25 mg/100 g or more.

7. The functional cereal of claim 1, in which either hulled or dehulled seeds are used.

8. The functional cereal of claim 2, in which either hulled or dehulled seeds are used.

9. The functional cereal of claim 1, which has a function of reducing an odor of stool.

10. The functional cereal of claim 2, which has a function of reducing an odor of stool.

11. The functional cereal of claim 3, which has a function of reducing an odor of stool.

12. The functional cereal of claim 1, in which the germination is performed with a solution with an acidic buffer.

13. The functional cereal of claim 12, wherein the solution is an acidic buffer solution or an acid solution at a concentration of 10 mmol to 500 mmol with pH of 2 to 6.

14. The functional cereal of claim 12, in which the germination is performed at a temperature between 0 and 35° C. for 3 to 24 hours.

15. The functional cereal of claim 12, in which the germination is performed in a sufficient amount of dissolved oxygen.

16. The functional cereal of claim 12, wherein the acidic buffer is a lactate buffer.

17. A process for producing functional a cereal of claim 1, in which the melatonin content and/or the dietary fiber content is increased by the germination in pH range between 2 and 6.

18. A processed food which is obtained by processing a functional cereal of claim 1, in which the melatonin content and/or the dietary fiber content is increased by the germination in pH range between 2 and 6.

19. A process for producing a germinated cereal, in which germination is conducted using melatonin as an index.

20. The process for producing a germinated cereal of claim 19, wherein the germinated cereal are any of the following a seed of brown rice, a dehulled barley or wheat, a bean or a corn.
